(19) United States
(12) Patent Application Publication
(10) Pub. No.: US 2024/0336484 A1
(43) Pub. Date: Oct. 10, 2024

(54) Process For Preparing A High Purity Hard Carbon Material For Sodium Ion Battery Application

(71) Applicant: Haycarb PLC, Colombo (LK)

(72) Inventors: Mirissa Sinharakkarage Prasanna UDAYAKUMARA, Colombo (LK); Jagodige Don SHISHIRA, Colombo (LK)

(21) Appl. No.: 18/628,370

(22) Filed: Apr. 5, 2024

(30) Foreign Application Priority Data
Apr. 6, 2023 (IN) 202311025995

(51) Int. Cl. C01B 32/05; H01M 4/02; H01M 4/133

(52) U.S. Cl. CPC C01B 32/05; H01M 4/133; C01P 2002/72; C01P 2004/51; C01P 2004/61; C01P 2006/11; C01P 2006/12; C01P 2006/40; C01P 2006/80; H01M 2004/027

(57) ABSTRACT

The invention discloses a process of making high purity hard carbon material from coconut shells for sodium ion battery application. The process has a lower carbon footprint as the alkali soluble lignin compounds of the coconut shells are extracted out during the de-mineralizing and are converted into a solid mass which is further used for organic composting. The released volatile matter during the subsequent charcoaling and de-volatilization are directed for complete combustion for recovery of waste heat energy. The obtained hard carbon material has particle size D₅₀ from 1-15 microns and metal impurities of Na, K, Ca, Mg, and Fe lower than 0.05% of each element (less than 500 ppm by weight). The naturally occurring interlayer width (d₀₀₂) of 0.37 nm-0.39 nm in irregular crystal structure of coconut shell charcoal helps to achieve good cycle life, high coulombic efficiency of >87%, and reversible capacity of 269-314 mAh/g in sodium ion battery applications.

### CROSS-REFERENCE TO RELATED APPLICATION

The present invention claims priority under 35 U.S.C. § 119 (a) from Indian application No. 20/231,1025995, filed Apr. 6, 2023.

### FIELD OF THE INVENTION

The present invention relates to a high purity hard carbon material for sodium ion battery application. More specifically, the present invention relates to an efficient and inexpensive process for preparing large quantities of a high purity hard carbon material from coconut shells. The said process to derive high purity hard carbon material is environment friendly with a low carbon footprint.

### BACKGROUND OF THE INVENTION

To meet the increasing demand of energy production and energy storage in day-to-day applications, lithium and sodium ion batteries have attracted a great deal of attention. Lithium-ion batteries (LIBs), being efficient and emission free, provide an ideal renewable energy solution for electronic vehicles. But, due to the high cost and limited availability of lithium sources and to mitigate the demand for high energy density battery requirement in the world, sodium ion batteries (SIBs) are considered as the best candidate for power sources. Sodium is widely available and exhibits similar chemistry to that of lithium (Li) in LIBs. Therefore, SIBs are a promising next-generation alternative for energy storage. But for practical development of efficient SIBs, suitable electrode material, suitable electrolytes, additives, and binders are equally important to be developed. Recently, sodiated layer transition metal oxides, phosphates and organic compounds have been introduced as cathode materials for SIBs. Simultaneously carbonaceous materials, transition metal oxides (or sulfides), and intermetallic and organic compounds are explored as anodes for SIBs.

In lithium-ion batteries, the commonly used anode material is graphite having 0.33 nm average interlayer spacing. However, for maintaining good performance, large automobile batteries require high durability of charge/discharge cycle. Non-graphitizable carbon is suitable for use in the application, as it involves little particle expansion and contraction due to lithium/sodium ion doping and de-doping. In WO2017/060718A1, to achieve higher charge/discharge capacity in sodium ion battery application, material comprising high purity hard carbon composite is suggested.

Conventionally, pitches, polymer compounds, and plant based organic materials have been sourced for non-graphitizable hard carbon. However, the removal of high levels of impurities from the petroleum pitch and coal base pitch having the property for making non-graphitizable hard carbon requires various treatments, and removal of them makes the process costly.

One of the most abundant raw materials to produce carbon at industrial scale is coconut shell. Coconut shell is mainly composed of lignified hard sclerenchyma tissue cells called sclereids (shown in FIG. 1) embedded with alkali and alkaline earth metals Na, K, Ca, Mg and Fe, Si, P and S. It is known that during the pyrolysis process and heat treatment to make charcoal and specialized carbon materials the lignocellulose material (Lignin) in sclereids decomposes to various hydrocarbons at different boiling temperature starting from 150° C. to 950° C. However, for deriving high purity hard carbon material from coconut shell, the concentration of alkali and alkaline earth metals in the coconut shell needs to be reduced to very low values.

A few of the prior suggested methods to derive carbonaceous materials from different plant sources are discussed hereinafter.

IN201617003087A discloses a method of forming activated carbon by carbonizing coconut shell material through heating in a temperature range of 600-1000° C. However, the method does not involve de-mineralisation of coconut shell precursor material prior to heating.

IN202111001722A deals with making hard carbon from rice straw wherein the rice straw is cut, washed in distilled water, ground to 100-300 microns and then soaked in 0.1-10 M acid solution for 1-24 h at 25-100° C. for further heat treatment. Similarly, IN202011048103A discloses a process for preparation of high-performance hard carbon electrode material for sodium ion batteries using cattle manure as a biomass precursor comprising the steps of drying and grinding of the biomass precursor and thereafter, treating it with 0.1 M to 5.0 M hydrofluoric acid solution (HF) for 1 h to 48 h, at a temperature between 25 to 60° C. followed by washing the material obtained with de-ionized water for further treatment.

IN201641043941A deals with adsorbent carbon that is made from cashew nut shells. The shells are first burnt, followed by a series of washing and drying steps wherein the shells are first washed with 0.1 N NaOH, dried and then washed with 0.01 N H₂SO₄ to remove the trace amounts of NaOH. However, no focus has been laid upon sequential de-mineralization of raw material in specific manner and nothing has been disclosed about the content of alkali and alkaline earth metals in the obtained carbon material which is required to ensure the high purity of the obtained carbon material.

US2015/0188137A1 describes making of an anode material with high purity for better cycle life and lower resistance (i.e., first cycle irreversible capacity) from different plant derived carbon materials. Further, the de-mineral treatment method used is limited to plant derived carbonaceous material from coffee beans in the working examples. Moreover, the comparative examples employ only hydrochloric acidic solution of pH 3 and above at room temperature to 100° C., without using ammonia or any alkali for neutralization of the demineralized material prior to de-tarring. Further, for the de-mineralization of carbonaceous material, very small particles of size 100 μm are used without taking into consideration the material losses incurred during the commercial preparation of smaller particle size, making the process inefficient. Moreover, for the temperature treatment, a maximum 1500° C. was used on 100 μm particles without considering difficulties to be faced in material handling in commercial operations.

Moreover, the prior art inventions about deriving hard carbon material from petroleum pitch and plant origins such as coffee bean residue and coconut shells for lithium ion and sodium ion battery anodes do not describe their environmental impact such as the release of hydrocarbon and CH₄ leading to an increased carbon footprint.

It can be understood that there is a need for high purity hard carbon material for sodium ion batteries and an efficient and inexpensive process for preparing large quantities of such hard carbon material. Further there is a requirement for an environment friendly process for producing high purity hard carbon material with a low carbon footprint.

### SUMMARY OF THE INVENTION

This summary is provided to introduce a selection of concepts, in a simplified format, that are further described in the detailed description of the invention.

The present invention provides a process for preparing a high purity hard carbon material from a coconut shell precursor material, the high purity hard carbon material is used in a sodium ion battery, wherein the process comprises the steps of:

Drying the coconut shell precursor material, wherein the drying of the coconut shell precursor material is performed at 100° C.-140° C.; crushing the dried coconut shell precursor material to obtain a crushed material with at least 90% of the particles in the indicated size range of 600-3600 micron size, wherein the crushing is performed in a crusher selected from a hammer mill crusher, or a roller mill crusher. Thereafter, screening the crushed material to remove fibres and very fine particles to get polished fibre free screened particles, wherein the screening of the crushed material is done by a gyratory reciprocating screener (e.g., ROTEX® Gyratory Reciprocating Screener).

Then de-mineralising of the crushed and screened material is done by ultra-washing, wherein the ultra-washing is performed alternately with 0.1 N acid solution and 0.1-0.2 N alkali solution, followed by washing with alkali solution having normality of 0.1-0.2 N to obtain a washed material, wherein the acid solution is selected from HCl and HNO₃ and the alkali solution is NH₄OH, and wherein the ultra-washing with acid is performed at a temperature in the range of 120° C.-150° C.

After ultra-washing, the particles are neutralized with a dilute acid solution to remove a reddish-brown fraction of lignin from a lignocellulose material of the coconut shell precursor material and to obtain a washed material. The reddish-brown fraction of lignin is extracted out, introduced into a settlement zone to settle down a lignin sludge, wherein the lignin sludge is converted into a compost.

Then heat treatment of the washed material is done at 500° C.-1800° C. to remove volatile hydrocarbons and gases and to get a heated material, wherein the heat treatment comprises carbonizing the washed material in a carbonizing kiln at 500° C.-700° C., followed by de-volatizing the carbonized material at 900° C.-1000° C., followed by high temperature heating of the de-volatilized material, wherein the high temperature heating is done at 1200° C.-1800° C.

The volatile hydrocarbons and gases released during carbonization, de-volatilization and heat treatment are CH₄, volatile organic compounds (VOC), H₂ and CO, wherein CH₄, VOC, H₂, and CO are combusted in a combustion chamber into CO₂ and H₂O and the combustion energy is used for steam generation and to operate an electric turbine.

Milling of the heated material is done to get 1-20 micron size of a milled material and de-magnetizing the milled material is done to obtain a de-magnetized material having Iron (Fe) content less than 10 ppm. This step helps in the reduction of iron metal impurities in the hard carbon material.

Thereafter, the de-magnetized material is classified to remove particles of size less than 1 micron and to obtain a classified material, wherein the classified material consists of particles of size less than 1 micron below 2%, the particles of size 1-2 microns are 9%-11% and the rest of the particles have a size greater than 2 microns

Vacuum drying of the classified material is done to obtain a vacuum dried high purity hard carbon material having moisture content less than 300 ppm, followed by packing the vacuum dried high purity hard carbon material by an online packer.

The present invention also provides a high purity hard carbon material obtained from a coconut shell precursor material, wherein a particle size D₅₀ of the hard carbon material is in a range of 1-15 microns. In an embodiment, the D₅₀ of the hard carbon material is from 5 to 12 microns. In an embodiment, the D₅₀ of the hard carbon material is from 6 to 10 microns. The hard carbon material consists of a crystal structure with an average interlayer spacing of 200 planes (d₀₀₂) and having 0.37 nm to 0.39 nm interlayer width, and the crystal structure is determined by powder X-ray diffraction.

The hard carbon material may comprise metal impurities of Na, K, Ca, Fe each lower than 2.5 ppm, and metal impurities of Mg lower than 5-6 ppm. The hard carbon material comprises oxygen (O) in a range of 0.29-0.51%, nitrogen (N) in a range of 0.01-0.24%, and hydrogen (H) in a range of 0.08-0.21%. In an embodiment, the high purity carbon material has less than 2.5 ppm of each of Na, K, and Ca, less than 10 ppm of Fe, and less than 6 ppm of Mg. In an embodiment the high purity carbon material has less than 2.5 ppm of each of Na, K, and Ca, less than 10 ppm of Fe, less than 6 ppm of Mg, and oxygen (O) in a range of 0.29-0.51%. In an embodiment the high purity carbon material has less than 2.5 ppm of each of Na, K, and Ca, less than 10 ppm of Fe, less than 5 ppm of Mg, and oxygen (O) in a range of 0.29-0.51%. In an embodiment the high purity carbon material has less than 2.5 ppm of each of Na, K, and Ca, less than 10 ppm of Fe, less than 6 ppm of Mg, oxygen (O) in a range of 0.29-0.51%, and nitrogen (N) in a range of 0.01-0.24%. In an embodiment the high purity carbon material has less than 2.5 ppm of each of Na, K, and Ca, less than 10 ppm of Fe, less than 6 ppm of Mg, oxygen (O) in a range of 0.29-0.51%, and nitrogen (N) in a range of 0.01-0.24%, and/or hydrogen (H) in a range of 0.08-0.21%. In any of those embodiments, the content of Fe may be less than 2.5 ppm. Unless stated otherwise the proportion of elements is assessed on a weight basis (e.g., percentage or ppm by weight).

The BET surface area of the hard carbon material is in a range of 10-14 m²/g, and the tap density is in the range of 0.77-0.85 g/cc.

The present invention also provides a sodium ion battery anode comprising the high purity hard carbon material, wherein the reversible capacity of the said anode is in the range of 269-314 mAh/g and the coulombic efficiency of the anode is 87% during first cycle.

### OBJECTIVES OF THE PRESENT INVENTION

The main objective of the present invention is to provide an environment friendly and cost-effective process to prepare a high purity hard carbon material in large quantities.

Another objective of the present invention is to derive the high purity hard carbon material from easily available coconut shells.

Another objective of the present invention is to provide a high purity hard carbon anode material for sodium ion battery application.

### BRIEF DESCRIPTION OF DRAWINGS

FIG. 1: (a) structure of sclereid cell, (b) a cross section of sclereid.

FIG. 2: Fraction of dark brown coloured alkali soluble lignin in liquid Ammonia.

FIG. 3: Flow chart showing the process steps for the preparation of high purity hard carbon material from coconut shell precursor material.

FIG. 4: Complete flow chart showing the associated process steps for lignin extraction and complete combustion of volatile hydrocarbon and gases, such as CH₄, volatile organic compounds (VOC), H₂ and CO, generated during the heat treatment.

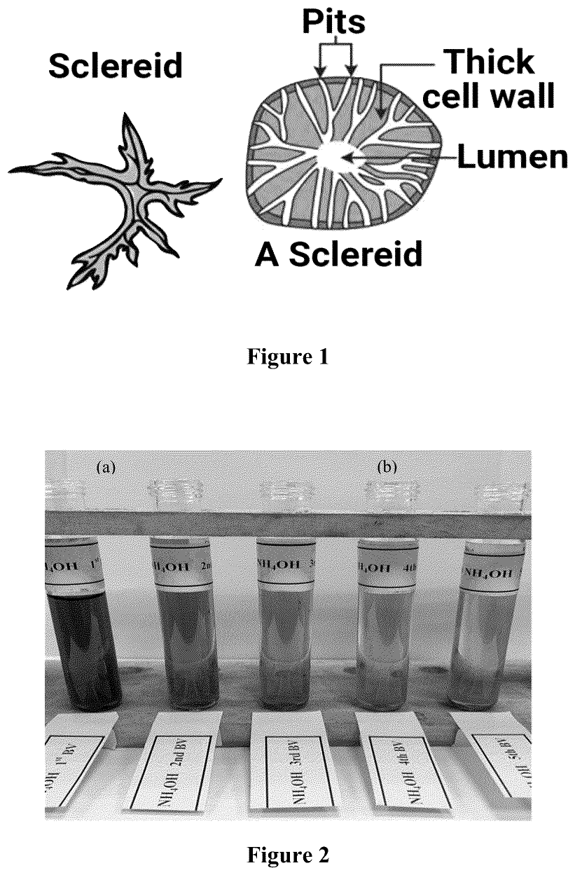

### DETAILED DESCRIPTION OF THE INVENTION

For the purpose of promoting an understanding of the principles of the invention, reference will now be made to the embodiments using specific language to describe the same. It will nevertheless be understood that no limitation of the scope of the invention is thereby intended, such alterations and further modifications in the illustrated compositions, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skill in the art to which this invention belongs. The compositions, methods, and examples provided herein are illustrative only and not intended to be limiting.

The articles “a”, “an” and “the” are used to refer to one or to more than one (i.e., to at least one) of the grammatical object of the article.

The terms “comprise” and “comprising” are used in the inclusive, open sense, meaning that additional elements may be included.

Throughout this specification, unless the context requires otherwise the word “comprise”, and variations such as “comprises” and “comprising”, will be understood to imply the inclusion of a stated element or step or group of elements or steps but not the exclusion of any other element or step or group of elements or steps.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods and materials are now described. All publications mentioned herein are incorporated herein by reference.

The terminology and structure employed herein is for describing, teaching, and illuminating some embodiments and their specific features and elements and does not limit, restrict, or reduce the spirit and scope of the invention.

The present invention provides a process for preparing a high purity hard carbon material from a coconut shell precursor material, the high purity hard carbon material being used in a sodium ion battery. The process includes the steps of:

Drying the coconut shell precursor material (100), to obtain a dried coconut shell precursor material before crushing to particles with at least 90% of the particles in the range of 600 microns to 3600 microns, wherein the drying is performed at 100° C.-140° C. in hot air blowing, until the material is dried with <10% moisture;

Crushing the dried coconut shell precursor material (101), to obtain crushed particles of the material having 90% of particles in the size range of from 600 microns to 3600 microns, wherein the crushing is performed in a crusher selected from a hammer mill crusher, or a roller mill crusher; and

Screening the crushed material (102), to remove fibres and very fine particles (e.g., particles less than 1,000 micron/1 mm) to get polished fibre free screened particles, wherein the screening of the crushed material is done by gyratory reciprocating screener.

The coconut shell precursor material can be purified to results in very low levels of alkali and alkaline earth metals by alternative acid and alkali washing at 120° C.-150° C.

It was observed by the inventors of the present invention that coconut shell precursor materials with 90% of the particles in the size range from 600 microns to 3600 microns is easily demineralized to achieve <2 ppm K, <2.5 ppm Na, <2.5 ppm Ca and <5-6 ppm Mg. This could further lower the process cost. Further, the particle size of 600 microns to 3600 microns is also easily carbonized and heat treated in an environment friendly manner until milling to a fine micron powder in the milling step.

In one feature of the present invention, de-mineralising of the crushed and screened material is done by ultra-washing (103), wherein the ultra-washing is performed by soaking the crushed and screened material into 0.1 N HCl or 0.1 N HNO₃ acid at a temperature in the range of 120° C.-150° C., and then washing with 2-5 bed volumes of 0.1-0.2 N NH₄OH, to remove alkali soluble lignin followed by precipitating the lignin into a solid mass. This reduces the alkali metals such as potassium (K), Sodium (Na) to less than 10 ppm and alkali earth metals calcium (Ca), magnesium (Mg) to less than 10 ppm in the obtained washed particles. Treatment with alkali solution (0.1 to 0.2 N) having a pH>10 in controlled conditions followed by neutralizing with dilute acid is done to remove a reddish brown fraction of lignin in lignocellulose material of the coconut shell. This also minimizes the release of hydrocarbons and volatile gases into environment during the heating process, which includes carbonization, de-volatilization, and high temperature heat treatment and helps in reducing the carbon footprint. These novel process steps are responsible for enhanced electrochemical performance of anode material developed with some rearrangement in the crystal structure of hard carbon due to the hydrolysis and removal of lignin monomers and dimers.

After ultra-washing, the washed particles with at least 90% of the granules (particles) in the range of 600 microns to 3600 microns are neutralized with a dilute acid solution to remove a reddish-brown fraction of lignin from a lignocellulose material of the coconut shell precursor material and to obtain a washed material. The reddish-brown fraction of lignin is extracted out, introduced into a settlement zone to settle down a lignin sludge, wherein the lignin sludge is converted into a compost.

Solubilizing lignin in the ammonia during de-mineralization reduces the release of volatile hydrocarbons during the carbonization and heat treatments, since the 10% of volatile hydrocarbon fraction is removed in the alkali washing step.

The heat treatment of the washed material is done at 500° C.-1800° C. to remove volatile hydrocarbons and gases and to get a heated material, wherein the heat treatment comprises carbonizing (104) the washed material in a carbonizing kiln at 500° C.-700° C., followed by de-volatizing (105) the carbonized material at 900° C.-1000° C., followed by high temperature heating (106) of the de-volatilized material.

The high temperature heat treatment is done at a temperature ranging from 1200° C. to 1800° C., preferably at 1550° C. At this temperature, the surface modification of hard carbon material happens which results into better cycle life and lower irreversible capacity. During this process the non-graphitized carbon material is formed with a reduced surface area (SA), tap density >0.85 g/cc, d₀₀₂>0.38 nm and oxygen (O) and hydrogen (H) each to carbon ratio <0.01.

The volatile hydrocarbons and gases released during carbonization, de-volatilization and heat treatment steps (104, 105, 106) are CH₄, volatile organic compounds (VOC), H₂ and CO, wherein CH₄, VOC, H₂, and CO are combusted in a combustion chamber of the flue gas into CO₂ and H₂O before releasing into the air. The heat energy generated by combustion energy is recovered and used for steam generation to operate an electric turbine which makes the process environmentally friendly.

Milling (107) and de-magnetization (108) of heat-treated carbon material in jet mills is performed to achieve D₅₀ of 1-15 microns without contaminating the milled hard carbon material with Fe from the mill. The Fe content is maintained at less than 10 ppm (e.g., less than 2.5 ppm).

Classification (109) of the milled and de-magnetized material is performed with jet milling and VCC (Vizier cyclone classifier) to remove particles of size <1 micron from the milled material in order to reduce the BET surface area, which is contributed by the external surface area of the fine powder. With the removal of particles of size <1 micron to at most 2% of the product, fine particles are maintained around 10% of particles (e.g., 8% to 12%) between 1 micron and 2 microns. In order to obtain better binding properties with good lamination of electrodes, the target product, having particles of size <1 micron at <2%, 1-2 micron particles at around 10% and D₅₀ of 5-15 microns, is maintained.

Vacuum drying (110) of the classified material is done to obtain a vacuum dried high purity hard carbon material having moisture content less than 300 ppm, since the moisture in hard carbon affects the making and final performance of the electrode, followed by packing (111) of the vacuum dried high purity hard carbon material by an online packer to avoid moisture pickup during the packing.

The present invention also provides a high purity hard carbon material obtained from a coconut shell precursor material, wherein a particle size D₅₀ of the said hard carbon material is in a range of 1-15 micron. The hard carbon material consists of a crystal structure with an average interlayer spacing of 200 planes (d₀₀₂) of 0.37 nm to 0.39 nm; wherein the crystal structure is determined by powder X-ray diffraction.

The hard carbon material may comprise metal impurities of Na, K, Ca, and Fe lower than 2.5 ppm, and metal impurities of Mg in a range of about 5 to about 6 ppm (e.g., from 5-6 ppm). The hard carbon material may comprise oxygen (O) in a range of 0.29-0.51%, nitrogen (N) in a range of 0.01-0.24%, and hydrogen (H) in a range of 0.08-0.21%.

The BET surface area of the hard carbon material is in a range of 10-14 m²/g, and the tap density is in the range of 0.77-0.85 g/cc.

The present invention also provides a sodium ion battery anode comprising the high purity hard carbon material, wherein the reversible capacity of the said anode is in the range of 269-314 mAh/g, and the coulombic efficiency of the anode is 87% during first cycle.

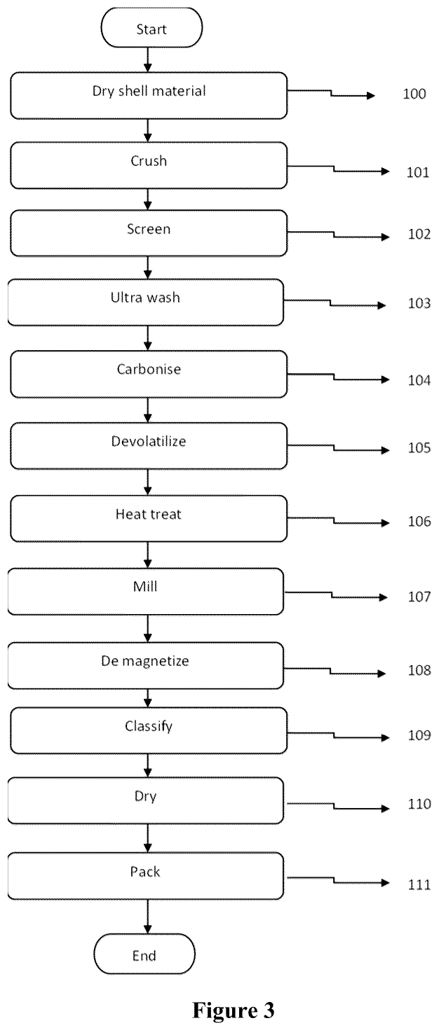

The process flow comprising the steps required for preparing high purity hard carbon material from coconut shell precursor material is described in FIG. 3.

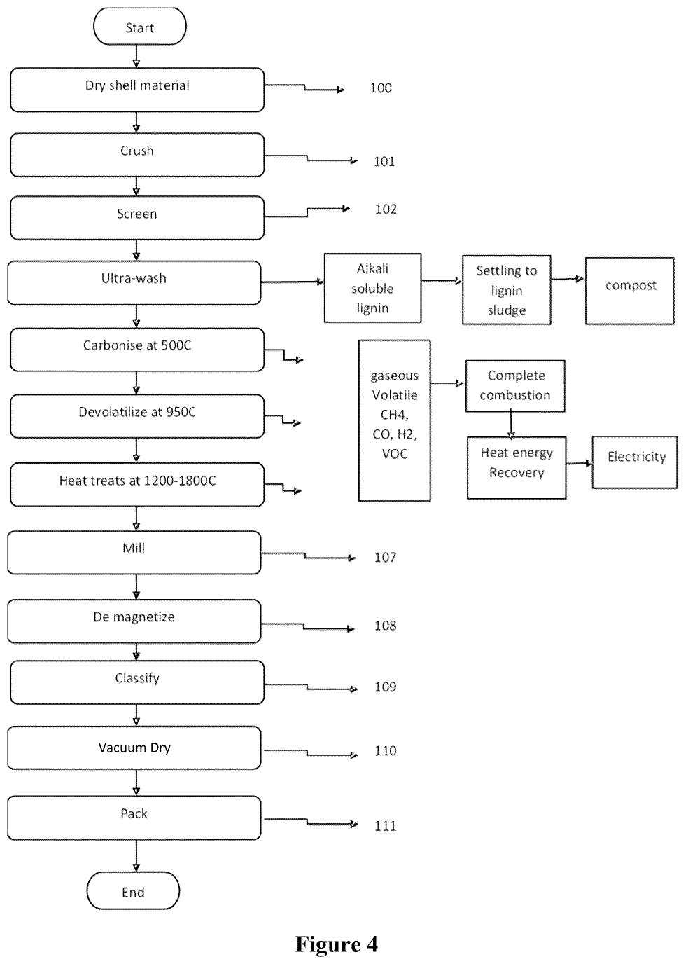

An embodiment of a complete process flow for preparing high purity hard carbon material along with conversion of lignin to compost and complete combustion of volatile gases is described in FIG. 4. In that embodiment the precursor material (100) is dried in a rotary dryer using blown hot air (about 120° C.) before crushing in a hammer mill to a particle size of from 600 microns to 3600 microns. The material is dried to <10% moisture measured in the oven drying method described in ASTM D2867-09.

Crushing (101) of the dried precursor material is conducted in a hammer mill crusher followed by crushing in a roller mill crusher to achieve particles of dried precursor material having a size distribution with at least 90% of the particles between 600 microns and 3600 microns as measured using ASTM E11 (ASTM E11-22) test sieves. Screening (102) of the crushed material is conducted in a rotary wire mesh screener to remove fibres and very fine particles, (<1,000 microns) resulting in polished fibre-free particles.

The polished fibre-free particles are ultra-washed (103) with 0.1 N HCl acid by soaking at room temperature, and then by alkali washing with 0.2 N NH₄OH 2-5 bed volumes (e.g., at a temperature in the range of 120° C.-150° C.) in order to remove alkali soluble lignin. The ultra-washed fibre-free particles are assessed for metal content using atomic adsorption spectrometry and returned values of the alkali metals K and Na each less than 10 ppm by weight and Ca and Mg each less than 10 ppm by weight. The particles are neutralized with dilute acid during which additional reddish brown lignin from the lignocellulose material of the coconut shell may be removed. Washings are combined and lignin precipitated into a solid mass (settling into sludge) for later composting (see the right side of FIG. 4).

The above-mentioned treatment using aqueous ammonia at greater than pH 10 (0.1 to 0.8 N) followed by neutralizing with dilute acid to remove a reddish brown fraction of lignin in lignocellulose material of the coconut shell minimizes the volatile gas released into the environment during the subsequent charring process resulting in a reduced carbon footprint. The controlled treatment also enhances the electrochemical performance of anode materials developed by providing some rearrangement of the crystal structure of the hard carbon due to the hydrolysis and removal of lignin monomers and dimers.

Carbonizing (104) is conducted at 500° C. to 700° C. in a rotary carbonizing kiln. Carbonizing is followed by heat treatment (105) at 900° C. to 1,000° C. in a high temperature furnace operated in an inert atmosphere for complete de-volatilization and high temperature treatment (106) at 1200° C. to 1800° C. The released hydrocarbon along with CH₄, H₂, and CO in those steps (steps 104, 105, and 106) are fully combusted in the combustion chamber at the >850° C. temperature of the flue gas, and the heat recovered using a boiler to generate steam for use in electrical generation (e.g., using a steam turbine driven electrical generator). During the carbonization and subsequent heating processes non-graphitized carbon is formed with a reduced surface area measured using Micromeritics ASAP2020, and the tap density is increased to greater than 0.85 g/cc. The Door measured by X-ray diffraction of the heated material was greater than 0.38 nm and the oxygen to carbon and hydrogen to carbon ratios are each less than 0.01.

Following carbonization and subsequent heat treatments (steps 104-106) the heat treated carbon material is subject to jet milling (107) to achieve particles with a D₅₀ in a desired range without introducing iron (Fe) contamination. Exemplary D₅₀ ranges include, but are not limited to, 1-2 microns, 2-3 microns, 3-4 microns, 3-5 microns 5-6 microns, 5-10 microns, 6-7 microns, 7-8 microns, 8-10 microns, 10-12 microns, 12-15 microns, and 15-20 microns. Particle size may be determined using a Beckman Coulter LS 13 320 Laser Diffraction Particle Size Analyzer using a dry module. The milled material is subsequently subjected to de-magnetization step (108).

Subsequent to de-magnetization the particles are subject to classification in step (109). Classification of the particles may be conducted employing an air particle classifier to remove particles less than 1 micron from the milled material. Removal of particles less than 1 micron reduces the BET surface area contributed by the external surface area of the fine particles. With the presence of particles less than 1 micron reduced to 2% or less, particles between 1 and 2 microns are maintained at approximately 10% in order to give better inter-particle binding of the hard carbon material and better lamination of the material upon the current collector (e.g., on aluminum foil support material). In an embodiment the milled and classified material comprises less than 2% of particles with a size less than 1 micron, about 10% particles (e.g., 8%-12%) in the size range of 1-2 microns, and D₅₀ is in the range of 5-6 microns. The proportion of particles (percentage of particles) of a given size is provided by volume (percent by volume) of the particles in a sample.

Following classification, the product may be subject to vacuum drying (110) to maintain the final product moisture content (e.g., moisture may be less than 300 ppm by weight). Moisture in hard carbon affects electrode production and may alter the electrode performance. Packing (111) of the material may be done using an online packer to avoid the introduction of moisture (e.g., moisture from air) during the packing.

### Analytical Methods and Discussion

Moisture (ppm) may be determined by the Coulometric Karl Fischer method, such as ASTM E1064-16 Standard Test Method for Water in Organic Liquids by Coulometric Karl Fischer Titration. Moisture in carbon material may be extracted into an organic liquid. The moisture content in the organic liquid may then be measured, and the moisture content of the carbon material may then be calculated from the measured amount of moisture in the organic liquid.

Bulk Density (g/cm³) is determined by Japanese Industrial Standard (JIS Method: K 1474-Test methods for activated carbon). The carbon material may be dried at about 115° C. prior to measurement. A manual filling method or automatic filling method may be used. The mass of a volume of material is measured.

Tap Density (g/cm³) involves applying a controlled force to settle particulates or powders. Typically a known weight of the carbon material is loaded into a measuring tube. The tube is then tapped a set number of times to allow the carbon material powder to settle. The volume of the settled carbon material powder is then recorded and used to calculate the tapped density. To tap the tube with the carbon material, a device to raise the tube (e.g., 3 mm to 14 mm) in a row in a vertical motion and then drop the tube for 250-300 times. Alternatively, but less consistently, the side of the tube may be patted about 100 times.

Ash content (%) may be measured per ASTM: D 2866 Standard Test Method for Total Ash Content of Activated Carbon. A known weight of carbon material may be placed in a temperature-controlled furnace, typically at about 650° C., for a period of time, typically for at least one hour. After cooling the remaining material is weighed to provide the ash content.

pH may be measured per ASTM: D 3838 Standard Test Method for pH of Activated Carbon.

Surface Area (BET-M) may be measured by ASTM D6556-21 Standard Test Method for Carbon Black—Total and External Surface Area by Nitrogen Adsorption. The total surface area is determined by the Brunauer, Emmett, and Teller (B.E.T. NSA) theory of multilayer gas adsorption behaviour using multipoint determinations and the external surface area based on the statistical thickness of the surface area method.

Interlayer spacing: D₀₀₂ (mm) may be determined by X-Ray Diffraction. A D8 Focus X-Ray Diffractometer from Bruker Corporation may be used to determine the interlayer spacing.

Particle Size Distribution (microns) may be determined by Laser Diffraction Particle Size Analyzer by Dry Module of Beckman Coulter LS 13 320 model. Results may be on a dry basis using Fraunhofer theory. Unless otherwise stated values herein are average or mean values.

Elemental Analysis, e.g., Fe content, Na content, K content, Ca content, and Mg content (ppm) may be determined by nitric acid extraction and analysis by inductively coupled plasma mass spectrometry (ICP-MS).

Oxygen content, Nitrogen content and Hydrogen content may be determined by use of Eltra ONH 2000 Analyzer from Eltra, part of the Verder Group, Haan, Germany.

Reversible Capacity (mAh/g) may be determined in accordance with test protocol guidelines by United States Advanced Battery Consortium LLC (USABC). Battery capacity is measured in milliamps times hours (mAH). Reversible capacity represents capacity that is delivered by an electrode, after several formation cycles of charge and discharge have been completed. Testing of sodium batteries may be similar to protocols for testing lithium batteries.

Initial Coulombic Efficiency (%) may be determined in accordance with test protocol guidelines by United States Advanced Battery Consortium LLC (USABC). Coulombic efficiency is the ratio between the number of electrons (units of electrical charge) transferred from one electrode of a battery cell to the other during charge and the number transferred back during discharge. The difference between these two numbers typically reflects the fact that some battery ions are lost during the charge/discharge process. The initial coulombic efficiency is based on the first cycle of charge and discharge.

### EXAMPLES

The present disclosure with reference to the accompanying examples describes the present invention. However, those of skill in the art should, in light of the present disclosure, appreciate that many changes can be made in the specific embodiments which are disclosed and still obtain a like or similar result without departing from the spirit and scope of the invention. It is understood that the examples are provided for the purpose of illustrating the invention only and are not intended to limit the scope of the invention in any way.

### Reduction in Volatile Content Through De-Mineralization

The total volatile matter content in the dried coconut shell material is in the range of 78-80% and with 20-22% of fixed carbon content. During de-tarring or carbonization at around 500° C. and de-volatilization at around 950° C., the total volatile matter is released as volatile hydrocarbon resulting into 20% of the non-volatilized fixed carbon mass ultimately produced from the hard carbon with subsequent heat treatments at elevated temperatures ranging from 1200° C. to 1800° C. to get the lowest O:C ratio<0.01.

The release of volatile hydrocarbon during hard carbon manufacture hugely affects the environment, and therefore the end battery markets need the sustainable green concept product and process for environmental sustainability. In the present invention the research team critically considered the possible reduction of the carbon footprint by the manufacture of environmentally friendly hard carbon.

The volatile matter released during carbonization and devolatilization are fully combusted in one or more combustion chambers into CO₂ and H₂O, and the combustion energy used to generate steam that drives one or more electrical generators coupled to steam turbines. The electricity generated may be used to power equipment employed in the process or otherwise. In contrast, during conventional carbonization at 500° C., 36 kg of methane per MT (metric ton) of charcoal is produced, which contributes to 20 times the equivalent CO₂ carbon footprint.

### Working Examples 1-5

In the present invention, the fraction of volatile matter contributing lignin is extracted out during the demineralizing process before the coconut shells are subjected for carbonization and de-volatilization processes. This reduces on average 10% of the volatile matter fraction as described in working examples in Table 1.

### Working Example 1

No de-mineralizing treatment is carried out for coconut shell particles with at least 90% of the granules (particles) in the size range of 3600 microns to 600 microns

### Working Example 2

De-mineralizing treatment is carried out by taking 500 g of coconut shell granules containing at least 90% of the granules (particles) in the size range of 3600 microns to 600 microns, washing with 500 ml of 0.1 N HCl, soaking for 45 minutes at 120° C.-150° C. and draining. The particles were rinsed with deionized water (DI) water three times, then the material was soaked in 500 ml of 0.1N NH₄OH. The process was repeated for 5 times, collecting the effluents of dark color extracted lignin for sedimentation (FIG. 2). For composting, the material is further neutralized with 500 ml of 0.1 N hydrochloric acid before rinsing with 500 ml DI water in triplicate.

### Working Example 3

Similar de-mineralizing treatment as of working example 2, except the concentration of NH₄OH used is 0.2 N.

### Working Example 4

Similar de-mineralizing treatment as of working example 2, except the concentration of NH₄OH used is 0.2 N.

### Working Example 5

Similar de-mineralizing treatment as of working example 2, except the concentration of NH₄OH used is 0.2 N.

TABLE 1
Carbon footprint contribution by coconut shell (CS)
for estimated 600 MT Hard carbon production per year.

| | | | Fixed | | Carbon |
|---|---|---|---|---|---|
| | | | carbon | Carbon | Footprint |
| | | Volatile | content | Footprint | reduction |
| | Material | matter % | % | (MT/yr) | (MT/yr) |
| Working | Coconut shell | 80 | 20 | 351 | 0 |
| example 1 | (CS) dry | | | | |
| Working | CS extracted | 79 | 21 | 306 | 45 |
| example 2 | with 0.1N | | | | |
| | NH₄OH | | | | |
| Working | CS extracted | 71 | 30 | 306 | 45 |
| example 3 | with 0.2N | | | | |
| | NH₄OH | | | | |
| Working | CS extracted | 70 | 30 | 306 | 45 |
| example 4 | with 0.2N | | | | |
| | NH₄OH | | | | |
| Working | CS extracted | 70 | 31 | 306 | 45 |
| example 5 | with 0.2N | | | | |
| | NH₄OH | | | | |

### Metal Reduction Through De-Mineralization

### Working Example 6

De-mineralizing treatment is carried out by (i) taking 500 g of coconut shell granules having at least 90% of the particles (granules) in the size range from 3600 microns to 600 microns and washing it with 500 ml of 0.1N HCl, soaking for 45 minutes at 120° C.-150° C. and draining, (ii) rinsing the granules with deionized water (DI) water three times, (iii) soaking the material in 500 ml of 0.2 N NH₄OH 5 times, and collecting the effluents of dark color extracted lignin from each of the 5 0.2 N NH₄OH soakings for sedimentation (see FIG. 2) and composting. The granular material is then neutralized with 500 ml of 0.1 N Hydrochloric acid before rinsing with 500 ml DI water in triplicate.

### Working Example 7

Similar de-mineralizing treatment as of working example 6 is carried out for the smaller coconut shell granules having at least 90% of the granules (particles) in the size range from 1700 microns to 420 microns.

### Working Example 8

Similar de-mineralizing treatment as of working example 6 is carried out for the bigger particle size coconut shell granules having at least 90% of the granules (particles) in the size range from 4500 microns to 2400 microns.

### Working Example 9

Repeat de-mineralization of working example 6 was done to reduce the metal content.

### Working Example 10

Further repeat de-mineralization of working example 9 was done for the confirmation of de-mineralizing step for achieving very low Na, K, Ca, Mg and Fe in the de-mineralized material prior to carbonization. The metal analysis is shown in table 2.

TABLE 2

| | Particle size | | | | | | |
|---|---|---|---|---|---|---|---|
| | range (μm)‡ | pH | K (ppm) | Na (ppm) | Ca (ppm) | Mg (ppm) | Fe (ppm) |
| Working example 6 | 3600 to 600 | 7.1 | <2.5 | <2.5 | <2.5 | 5.6 | <2.5 |
| Working example 7 | 1700 to 420 | 7.0 | <2.5 | <2.5 | <2.5 | 3.5 | <2.5 |
| Working example 8 | 4500 to 2400 | 7.0 | 20 | 12 | 18 | 22 | 7 |
| Working example 9 | 3600 to 600 | 6.9 | <2.5 | <2.5 | <2.5 | 5.0 | <2.5 |
| Working example 10 | 3600 to 600 | 7.1 | <2.5 | <2.5 | <2.5 | 6.0 | <2.5 |

‡at least the 90% of particle are in the indicated size range

### Carbonization and Heat Treatment

The de-mineralized coconut shell of working example 6, 9 & 10 is carbonized at 450-550° C., thereby releasing volatile hydrocarbons that may be subjected to full combustion into CO₂ and H₂O.

The carbonized material is treated at 940-960° C. for complete de-volatilization, and released volatile hydrocarbons that may be subjected to full combustion to CO₂ and H₂O.

The de-volatilized material is subjected to high temperature heat treatment ranging from 1200° C. to 1800° C. and the resulting material is subjected to BET Surface area measurement, O:C ratio measurement, and inter layer width (d₀₀₂) measurement using XRD before subjected for milling and classifying to final particle size of hard carbon.

The volatile hydrocarbons generated by carbonization and heat treatment may be used as fuel to drive the production of electricity as discussed above.

### Working Example 11

De-volatilized material is heat treated under inert condition at 1275° C. and their BET surface area and ONH is measured, also the inter layer width (d₀₀₂) is measured using XRD.

### Working Example 12

De-volatilized material is heat treated under inert condition at 1475° C. and their BET surface area and ONH is measured, also the inter layer width (d₀₀₂) is measured using XRD.

### Working Example 13

De-volatilized material is heat treated under inert condition at 1575° C. and their BET surface area and ONH is measured, also the inter layer width (d₀₀₂) is measured using XRD.

### Working Example 14

De-volatilized material is heat treated under inert condition at 1600° C. and their BET surface area and ONH is measured, also the inter layer width (d₀₀₂) is measured using XRD.

### Working Example 15

De-volatilized material is heat treated under inert condition at 1800° C. and their BET surface area and ONH is measured, also the inter layer width (d₀₀₂) is measured using XRD.

The BET surface area, inter planar spacing of 200 planes and percentage content of O, N and H in the particles of working examples 11-15 after carbonization and heat treatment is shown in table 3.

TABLE 3

| | Particle size | Treatment | BET N₂ | | | | |
|---|---|---|---|---|---|---|---|
| | range (μm) ‡ | Temperature (° C.) | SSA (m²/g) | d₀₀₂ (nm) | O % | N % | H % |
| Working example 11 | 3600 to 600 | 1275 | 12 | 0.379 | 0.51 | 0.24 | 0.21 |
| Working example 12 | 3600 to 600 | 1475 | 10 | 0.371 | 0.51 | 0.01 | 0.09 |
| Working example 13 | 3600 to 600 | 1575 | 14 | 0.377 | 0.32 | 0.01 | 0.09 |
| Working example 14 | 3600 to 600 | 1600 | 11 | 0.379 | 0.33 | 0.01 | 0.08 |
| Working example 15 | 3600 to 600 | 1800 | 13 | 0.367 | 0.29 | 0.01 | 0.08 |

‡ at least the 90% of particle are in the indicated size range

### Milling and Classifying

Milling and classification of heat-treated particles of size 3600 microns×600 microns size is done using jet milling and VCC (Vizier cyclone classifier) to remove <1 micron particles with a target D₅₀ of 5-15 micron. Classification into other D₅₀ ranges may also be done, including but not limited to, D₅₀ values in a range selected from: 1-2 microns, 2-3 microns, 3-4 microns, 3-5 microns 5-6 microns, 5-10 microns, 6-7 microns, 7-8 microns, 8-10 microns, 10-12 microns, 12-15 microns, and 15-20 microns. Particles less than 1 micron may be limited to less than 2% in any of those ranges of D₅₀ values.

The tap density, BET surface area, inter planar spacing of 200 planes, and D₅₀ particle size after milling and classifying for working examples 16-20 is shown in table 4.

TABLE 4

| | Treatment | Tap | | | |
|---|---|---|---|---|---|
| | Temperature | Density | BET N₂ | d₀₀₂ | D₅₀ |
| | (0° C.) | (g/cc) | SSA (m²/g) | (nm) | (μm) |
| Working | 1275 | 0.77 | 12 | 0.379 | 8.2 |
| example 16 | | | | | |
| Working | 1475 | 0.85 | 10 | 0.371 | 8.3 |
| example 17 | | | | | |
| Working | 1575 | 0.83 | 14 | 0.377 | 8.3 |
| example 18 | | | | | |
| Working | 1600 | 0.82 | 11 | 0.379 | 8.8 |
| example 19 | | | | | |
| Working | 1800 | 0.85 | 13 | 0.367 | 7.4 |
| example 20 | | | | | |

### Electrochemical Performance

The high purity hard carbon material obtained from coconut shell carbonaceous material by the novel environment friendly de-mineralizing, carbonizing, de-volatilizing and heat treatment process, may be utilized as anode material in sodium ion batteries. The high purity hard carbon material has physical and electrochemical performance suitable for commercial use as an anode material in sodium ion batteries as shown in table 5.

TABLE 5

| | Treatment | | | 1^{st} | Reversible |
|---|---|---|---|---|---|
| | Temperature | BET N₂ | d₀₀₂ | cycle | capacity |
| | (° C.) | SSA (m²/g) | (nm) | CE % | (mAh/g) |
| Working | 1275 | 12 | 0.379 | 85 | 289 |
| example 21 | | | | | |
| Working | 1475 | 10 | 0.371 | 87 | 314 |
| example 22 | | | | | |
| Working | 1575 | 14 | 0.377 | 80 | 280 |
| example 23 | | | | | |
| Working | 1600 | 11 | 0.379 | 87 | 269 |
| example 24 | | | | | |
| Working | 1800 | 13 | 0.367 | 82 | 285 |
| example 25 | | | | | |

We claim:

1. A process for preparing a high purity hard carbon material from a coconut shell precursor material, wherein the process comprises the steps of:
a) drying the coconut shell precursor material;
b) crushing the dried coconut shell precursor material to obtain a crushed material comprised of particles having a sized distribution with 90% of the particles in the range of 600-3600 microns;
c) screening the crushed material to remove fibres and very fine particles to obtain polished fibre free screened particles;
d) de-mineralising the crushed and screened material by ultra-washing alternately with an acid solution, and with an alkali solution, followed by washing with alkali solution to obtain a washed material;
e) heat treatment of the washed material to remove volatile hydrocarbons and gases, wherein the heat treatment is conducted at 500° C.-1800° C. to obtain a heated material;
f) milling the heated material to get 1-20 micron size of a milled material and de-magnetizing the milled material to obtain a de-magnetized material having Iron (Fe) content less than 10 ppm;
g) classifying the de-magnetized material to remove particles of size less than 1 micron and to obtain a classified material having a particular particle size range;
h) vacuum drying the classified material to obtain a vacuum dried high purity hard carbon material having moisture content less than 300 ppm; and
i) packing the vacuum dried high purity hard carbon material by an online packer;
wherein the high purity hard carbon material is suitable for use in a sodium ion battery.

2. The process as claimed in claim 1, wherein drying of the coconut shell precursor material is performed at 100° C.-140° C.

3. The process as claimed in claim 1, wherein the crushing is performed in a hammer mill crusher or a roller mill crusher.

4. The process as claimed in claim 1, wherein the screening the crushed material is done by a gyratory reciprocating screener.

5. The process as claimed in claim 1, wherein the ultra-washing is performed alternately with 0.1 N acid solution and 0.1-0.2 N alkali solution, wherein the acid solution is selected from HCl and HNO₃ and the alkali solution is NH₄OH.

6. The process as claimed in claim 1, wherein the ultra-washing with acid is performed at a temperature in the range of 120° C.-150° C.

7. The process as claimed in claim 1, wherein the heat treatment comprises carbonizing the washed material in a carbonizing kiln at 500° C.-700° C., followed by de-volatizing the carbonized material at 900° C.-1000° C., followed by high temperature heating of the de-volatilized material, wherein the high temperature heating is done at 1200° C.-1800° C.

8. The process as claimed in claim 1, wherein the volatile hydrocarbons and gases released during carbonization, de-volatilization and heat treatment are CH₄, volatile organic compounds (VOC), H₂ and CO, wherein the CH₄, VOC, H₂, and CO are combusted in a combustion chamber into CO₂ and H₂O and the combustion energy is optionally used for steam generation and/or electrical generation through the operation of an electric turbine.

9. The process as claimed in claim 1, wherein after ultra-washing, the screened particles are neutralized with a dilute acid solution to remove a reddish-brown fraction of lignin from a lignocellulose material of the coconut shell precursor material.

10. The process as claimed in claim 9, wherein the reddish-brown fraction of lignin is extracted out and introduced into a settlement zone to settle down as a lignin sludge, wherein the lignin sludge is optionally converted into a compost.

11. The process as claimed in claim 1, wherein the classified material comprises less than 2% of particles having a size less than 1 micron, 9%-11% of the particles having a size from 1 to 2 microns, and the remainder of the particles having a size in the range of 5-15 microns.

12. A high purity hard carbon material obtained from a coconut shell precursor material, wherein a particle size D₅₀ of said hard carbon material is in a range of 1-20 microns.

13. The high purity hard carbon material as claimed in claim 12, wherein the hard carbon material is comprised of a crystal structure with an average interlayer spacing of 200 planes (d₀₀₂) and having 0.37 nm to 0.39 nm interlayer width, and the crystal structure is determined by powder X-ray diffraction.

14. The high purity hard carbon material as claimed in claim 12, wherein the hard carbon material comprises less than 2.5 ppm of each of Na, K, Ca, and Fe by weight, and about 5 to about 6 ppm of Mg by weight.

15. The high purity hard carbon material as claimed in claim 12, wherein the hard carbon material comprises oxygen (O) in a range of 0.29-0.51%, nitrogen (N) in a range of 0.01-0.24%, and hydrogen (H) in a range of 0.08-0.21% by weight; and wherein an oxygen to carbon and a hydrogen to carbon ratio are less than 0.01.

16. The high purity hard carbon material as claimed in claim 12, wherein a BET surface area of the hard carbon material is in a range of 10-14 m²/g.

17. The high purity hard carbon material as claimed in claim 12, wherein the tap density of the hard carbon material is in a range of 0.77-0.85 g/cc.

18. A sodium ion battery anode comprising the high purity hard carbon material as claimed in claim 12.

19. The sodium ion battery anode as claimed in claim 18, wherein a reversible capacity of said anode is in a range of 269-314 mAh/g.

20. The sodium ion battery anode as claimed in claim 18, wherein a coulombic efficiency of the anode is 87% during a first cycle.
